(19) United States
(12) Patent Application Publication
(10) Pub. No.: US 2025/0360719 A1
(43) Pub. Date: Nov. 27, 2025

(54) DTF CONTINUOUS INK SUPPLY DEVICE WITH BUILT-IN STIRRING FUNCTION

(71) Applicant: SainStore Technology Co., Ltd., Dongguan (CN)

(72) Inventors: Hua Liao, Shenzhen (CN); Ting Xiang, Shenzhen (CN)

(21) Appl. No.: 18/985,623

(22) Filed: Dec. 18, 2024

(30) Foreign Application Priority Data
May 21, 2024 (CN) 202421102871X

(51) Int. Cl. B41J 2/175; B01F 27/112; B01F 35/32; B01F 101/35; B41J 29/42

(52) U.S. Cl. CPC B41J 2/175; B01F 27/112; B01F 35/32025; B01F 35/3204; B41J 29/42; B01F 2101/35

(57) ABSTRACT

A DTF continuous ink supply device with a built-in stirring function, comprising a box body and a box cover, the box body and the box cover are installed and connected in a detachable up-and-down structure, ink bottles are installed in the box body, the ink bottles are arranged in six groups, wherein two of the groups are white ink bottles, each white ink bottle is provided with a stirring paddle, a motor is installed on an internal top wall of each white ink bottle, a rotating shaft of the stirring paddle is connected to an output end of the motor. The invention relates to the technical field of ink supply devices.

### 1. TECHNICAL FIELD

The invention relates to the technical field of ink supply devices, in particular to a DTF (Direct to Film) continuous ink supply device with a built-in stirring function.

### 2. BACKGROUND ART

Inkjet printers typically use an ink cartridge that can be separated from the main unit to supply ink to the printhead. The main structure of the ink cartridge includes an ink chamber that holds the ink, a box cover at the top of the ink chamber is provided with a vent hole that connects the ink chamber to the atmosphere, while the bottom is provided with an ink outlet. When the ink cartridge is installed in the printer, the ink outlet or the sealing component inside the ink outlet aligns with the ink supply sealing component of the printhead to ensure a continuous and stable ink supply from the ink chamber to the printhead.

Existing continuous ink supply devices are prone to sedimentation and clogging when storing white ink, which affects printing efficiency. Therefore, there is an urgent need for a DTF continuous ink supply device with a built-in stirring function.

### 3. SUMMARY OF THE INVENTION

In order to solve the problem that existing continuous ink supply devices are prone to sedimentation and clogging when storing white ink, the invention provides a DTF continuous ink supply device with a built-in stirring function.

In order to realize the above functions, the invention adopts the following technical scheme: the DTF continuous ink supply device with a built-in stirring function, comprising a box body and a box cover, the box body and the box cover are installed and connected in a detachable up-and-down structure, ink bottles are installed in the box body, the ink bottles are arranged in six groups, wherein two of the groups are white ink bottles, each white ink bottle is provided with a stirring paddle, a motor is installed on an internal top wall of each white ink bottle, a rotating shaft of the stirring paddle is connected to an output end of the motor.

As a preferred technical scheme of the invention, ink tube joints are arranged on a rear side wall of the box body, and each of the ink bottles is provided with a built-in silicone tube.

As a preferred technical scheme of the invention, the box cover is provided with a power indicator light and a stirring indicator light, and the box cover is provided with a power button.

As a preferred technical scheme of the invention, the box cover is provided with a built-in battery, and the box cover is provided with a battery charging interface.

As a preferred technical scheme of the invention, each ink bottle is threadedly and detachably connected with a cap.

As a preferred technical scheme of the invention, a top of the box cover is provided with magnetic blocks.

Compared with the prior art, the invention has the following advantages: each white ink bottle for storing white ink is provided with a stirring paddle, the motor drives the stirring paddle to rotate and stir, preventing the white ink from settling during prolonged standing, which could affect the final printing quality, thereby improving the effectiveness of DTF printing and enhancing the durability of the printer.

### 4. BRIEF DESCRIPTION OF ACCOMPANY DRAWINGS

FIG. 1 is a schematic diagram 1 of the overall structure of a DTF continuous ink supply device with a built-in stirring function proposed by the invention.

FIG. 2 is a schematic diagram 2 of the overall structure of the DTF continuous ink supply device with the built-in stirring function proposed by the invention.

FIG. 3 is an exploded view of the DTF continuous ink supply device with the built-in stirring function proposed by the invention.

FIG. 4 is a schematic diagram of the structure of the ink box of the DTF continuous ink supply device with the built-in stirring function proposed by the invention.

FIG. 5 is a schematic diagram of the structure of the stirring paddle of the DTF continuous ink supply device with the built-in stirring function proposed by the invention.

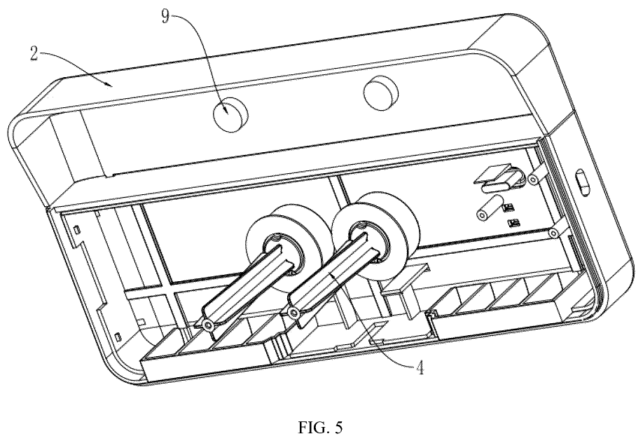

In the figures: 1 box body, 2 box cover, 3 ink bottle, 4 stirring paddle, 5 ink tube joint, 6 power indicator light, 7 stirring indicator light, 8 power button, 9 magnetic block, 10 battery charging interface, 11 cap, 12 white ink bottle.

### 5. SPECIFIC EMBODIMENT OF THE INVENTION

The technical schemes in the embodiments of the invention will be clearly and completely described in combination with the accompanying drawings in the embodiments of the invention. Obviously, the described embodiments are only some of the embodiments of the invention, but not all of the embodiments. Based on the embodiments in this invention, all other embodiments obtained by those of ordinary skill in the art without making creative efforts shall fall within the protection scope of this invention.

In the description of the invention, it should be understood that the orientation or positional relationship indicated by the terms “center”, “upper”, “lower”, “left”, “right”, “vertical”, “horizontal”, “inner”, “outer” and so on are based on the orientation or positional relationship shown in the accompanying drawings, or the orientation or positional relationship that product of the invention is usually placed in when it is used, only for the convenience of describing the invention and simplifying the description, rather than indicating or implying that the indicated device or element must have a specific orientation, as well as a specific orientation structure and operation, therefore, it should not be construed as a limitation of the invention. In addition, the terms of “first”, “second”, “third” and so on are only used to differentiate the description, and should not be construed as indicating or implying relative importance.

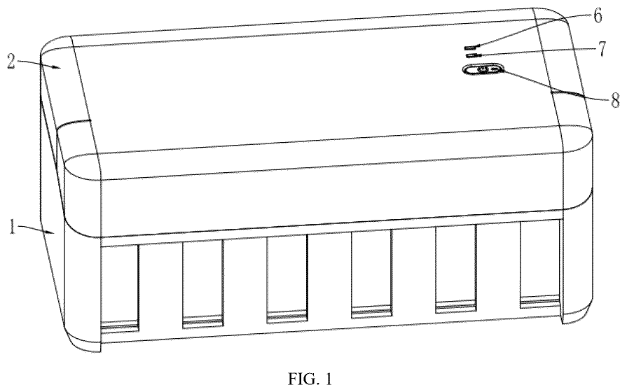

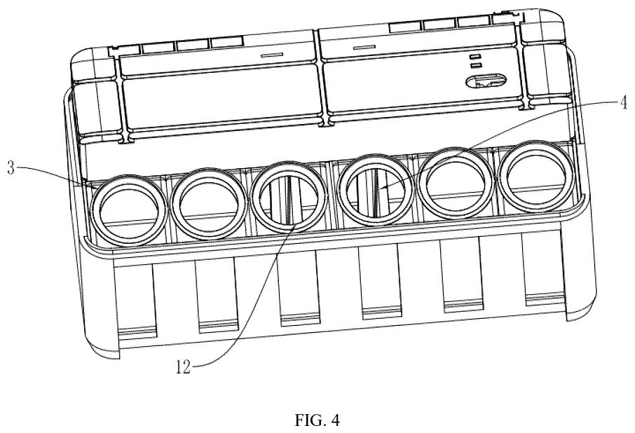

As shown in FIG. 1-4, a DTF continuous ink supply device with a built-in stirring function, comprising a box body 1 and a box cover 2, the box body 1 and the box cover 2 are installed and connected in a detachable up-and-down structure, ink bottles 3 are installed in the box body 1, each ink bottle 3 is threadedly and detachably connected with a cap 11, the ink bottles 3 are arranged in six groups, wherein two of the groups are white ink bottles 12 for storing white ink, each white ink bottle is provided with a stirring paddle 4, a motor is installed on an internal top wall of each white ink bottle 12, a rotating shaft of the stirring paddle 4 is connected to an output end of the motor; the motor drives the stirring paddle 4 to rotate and stir, preventing the white ink from settling during prolonged standing, which could affect the final printing quality, thereby improving the effectiveness of DTF printing and enhancing the durability of the printer.

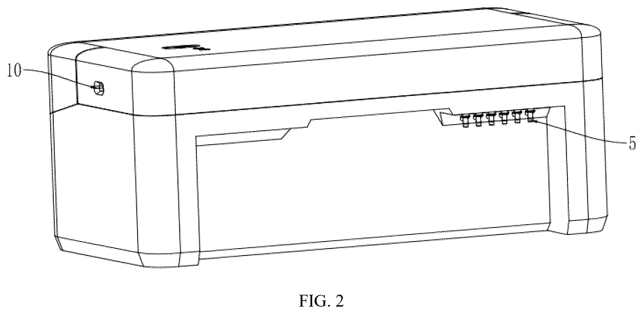

As shown in FIG. 2, ink tube joints 5 are arranged on a rear side wall of the box body 1, and each of the ink bottles 3 is provided with a built-in silicone tube; six silicone tubes are connected to the corresponding ink tube joints 5, and the ink tube joints 5 are connected to the printer.

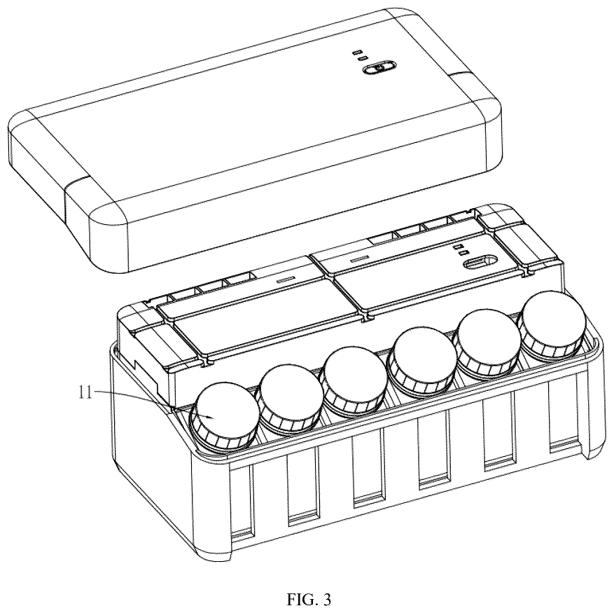

As shown in FIGS. 1 and 3, the box cover 2 is provided with a power indicator light 6 and a stirring indicator light 7, and the box cover 2 is provided with a power button 8; when the device is operating at a normal voltage, the power is turned on, and the power indicator light 6 will be white; when the device is at a low working voltage, the power is turned on, and the power indicator light 6 will be blue; a short press of the power button 8 will power on the device and activate the default stirring mode, and in this mode, the indicator light flashes, and the default stirring cycle: stir for 3 minutes, then pause for 1 minute, repeating this cycle; while the device is powered on, pressing the power button 8 again will activate the forced stirring mode, the indicator light flashes, and the forced stirring mode: the stirring lasts for 15 minutes before switching back to the default stirring mode.

As shown in FIG. 2, the box cover 2 is provided with a built-in battery that powers the entire device; the box cover 2 is provided with a battery charging interface 10, which allows for the charging of the battery; a top of the box cover 2 is provided with magnetic blocks 9 to prevent the cover from drooping, making it easier to pour ink.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A DTF continuous ink supply device with a built-in stirring function, comprising a box body and a box cover, the box body and the box cover are installed and connected in a detachable up-and-down structure, ink bottles are installed in the box body, the ink bottles are arranged in six groups, wherein two of the groups are white ink bottles, each white ink bottle is provided with a stirring paddle, a motor is installed on an internal top wall of each white ink bottle, a rotating shaft of the stirring paddle is connected to an output end of the motor.

2. The DTF continuous ink supply device with the built-in stirring function of claim 1, wherein ink tube joints are arranged on a rear side wall of the box body, and each of the ink bottles is provided with a built-in silicone tube.

3. The DTF continuous ink supply device with the built-in stirring function of claim 2, wherein the box cover is provided with a power indicator light and a stirring indicator light, and the box cover is provided with a power button.

4. The DTF continuous ink supply device with the built-in stirring function of claim 3, wherein the box cover is provided with a built-in battery, and the box cover is provided with a battery charging interface.

5. The DTF continuous ink supply device with the built-in stirring function of claim 4, wherein each ink bottle is threadedly and detachably connected with a cap.
